(19) United States
(12) Patent Application Publication
(10) Pub. No.: US 2023/0276852 A1
(43) Pub. Date: Sep. 7, 2023

(54) ELECTRONIC VAPORIZATION DEVICE AND VAPORIZER THEREOF AND VAPORIZATION CORE

(71) Applicant: SHENZHEN SMOORE TECHNOLOGY LIMITED, Shenzhen (CN)

(72) Inventors: Wu Chen, Shenzhen (CN); Xueqin He, Shenzhen (CN); Runda Li, Shenzhen (CN); Qiang Li, Shenzhen (CN); Congwen Xiao, Shenzhen (CN); Xiaoping Li, Shenzhen (CN); Lingrong Xiao, Shenzhen (CN)

(21) Appl. No.: 18/174,119

(22) Filed: Feb. 24, 2023

Related U.S. Application Data
(63) Continuation of application No. PCT/CN2021/114812, filed on Aug. 26, 2021.

(30) Foreign Application Priority Data
Aug. 31, 2020 (CN) 202010897894.4

(51) Int. Cl. A24F 40/46; H05B 3/42; A24F 40/10; A24F 40/44

(52) U.S. Cl. CPC A24F 40/46; H05B 3/42; A24F 40/10; A24F 40/44

(57) ABSTRACT

A vaporization core includes: a liquid absorbing element having a vaporization surface and a liquid absorbing surface that are oppositely arranged, the liquid absorbing element being arranged for a vaporizable liquid to enter from a side of the liquid absorbing surface and permeate toward a side of the vaporization surface; and a heating module having a heating element for heating the vaporizable liquid and connectors connected to two ends of the heating element, the heating element including a first heating portion and a second heating portion connected in series to the first heating portion. The first heating portion is arranged on a side of the vaporization surface. The second heating portion is embedded in the liquid absorbing element, extends toward a side of the liquid absorbing surface, and is located between the vaporization surface and the liquid absorbing surface.

### CROSS-REFERENCE TO PRIOR APPLICATION

This application is a continuation of International Patent Application No. PCT/CN2021/114812, filed on Aug. 26, 2021, which claims priority to Chinese Patent Application No. 202010897894.4, filed on Aug. 31, 2020. The entire disclosure of both applications is hereby incorporated by reference herein.

### FIELD

This application belongs to the technical field of electronic vaporization devices, and in particular, to an electronic vaporization device and a vaporizer thereof and a vaporization core.

### BACKGROUND

The existing electronic vaporization devices such as e-cigarettes can usually vaporize a vaporizable liquid such as e-liquid. Generally, a ceramic base may be used to communicate with a liquid storage space of the vaporizable liquid, so that the vaporizable liquid in the liquid storage space can permeate out from a side of the ceramic base. A heating module may be generally arranged on a side of the ceramic substrate away from the liquid storage space of the vaporizable liquid to heat and vaporize the permeated vaporizable liquid.

However, for the existing metal heating module, since the heating module is embedded on the surface of the ceramic base and then sintered together into a whole, and due to the difference between thermal conductivities of the heating module and the ceramic base, the heating module may be slightly separated from the ceramic after heating, which may cause problems such as uneven heating temperature when the vaporizable liquid is heated in subsequent use, a poor vaporization effect of the vaporizable liquid, and even burnt smell and peculiar smell in severe cases. In addition, for the vaporizable liquid with high viscosity, the liquid guide rate of the ceramic base will decrease, so that the vaporizable liquid supply on the ceramic surface provided with the heating module is insufficient, resulting in dry burning.

### SUMMARY

In an embodiment, the present invention provides a vaporization core, comprising: a liquid absorbing element comprising a vaporization surface and a liquid absorbing surface that are oppositely arranged, the liquid absorbing element being configured for a vaporizable liquid to enter from a side of the liquid absorbing surface and permeate toward a side of the vaporization surface; and a heating module comprising a heating element configured to heat the vaporizable liquid and connectors connected to two ends of the heating element, the heating element comprising a first heating portion and a second heating portion connected in series to the first heating portion, wherein the first heating portion is arranged on a side of the vaporization surface, and wherein the second heating portion is embedded in the liquid absorbing element, extends toward a side of the liquid absorbing surface, and is located between the vaporization surface and the liquid absorbing surface.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 is a schematic structural diagram of an embodiment of a vaporization core according to this application.

FIG. 2 is a schematic structural diagram of a heating module in the vaporization core shown in FIG. 1.

FIG. 3 is a schematic structural diagram of another implementation of the vaporization core shown in FIG. 1.

FIG. 4 is a schematic structural diagram of a heating module in the vaporization core shown in FIG. 3.

FIG. 5 is a schematic structural diagram of an embodiment of a vaporizer according to this application.

FIG. 6 is a cross-sectional view of the vaporizer shown in FIG. 5.

FIG. 7 is a partial enlarged view of the vaporizer shown in FIG. 6 in a region A.

FIG. 8 is a schematic structural diagram of an embodiment of an electronic vaporization device according to this application.

### DETAILED DESCRIPTION

In an embodiment, the present invention provides an electronic vaporization device and a vaporizer thereof and a vaporization core, so as to resolve the above technical problem.

In an embodiment, the present invention provides A vaporization core. The vaporization core includes:
a liquid absorbing element, including a vaporization surface and a liquid absorbing surface that are oppositely arranged, where the liquid absorbing element is configured for a vaporizable liquid to enter from a side of the liquid absorbing surface and permeate toward a side of the vaporization surface; and
a heating module, including a heating element configured to heat the vaporizable liquid and connectors connected to two ends of the heating element, where the heating element includes a first heating portion and a second heating portion connected to the first heating portion.

The first heating portion is arranged on the side of the vaporization surface, and the second heating portion is embedded in the liquid absorbing element, extends toward the side of the liquid absorbing surface, and is located between the vaporization surface and the liquid absorbing surface.

Optionally, the vaporization surface is a plane.

Optionally, at least two first heating portions are arranged, each of the two first heating portions is connected to one of the connectors, and the second heating portion is connected in series between the two first heating portions.

Optionally, at least two second heating portions are arranged, and two ends of each of the two second heating portions are respectively connected in series to a corresponding one of the first heating portions.

Each of the second heating portions includes at least two first heating sub-portions and a second heating sub-portion, and two ends of each of the first heating sub-portions are respectively connected to the first heating portion and the second heating sub-portion.

The at least two first heating portions are arranged in a first plane. The second heating sub-portion is arranged in a second plane spaced apart from the first plane.

Optionally, the at least two first heating portions are both arranged on the side of the vaporization surface and contact the vaporization surface.

Optionally, the second plane is parallel to and spaced apart from the first plane.

Optionally, the heating element is a linear heating unit, and the first heating portion and the second heating sub-portion are both linear.

Optionally, a plurality of through holes or blind holes are formed on the heating element, and the plurality of through holes or blind holes are arranged at intervals in a length direction of the heating element.

Optionally, the heating element is a metal sheet, and the heating element is integrally formed with the connectors arranged at two ends of the heating element.

Optionally, the heating element is a metal wire, and the heating element is bent a plurality of times to form the at least two first heating portions and the second heating portion.

Optionally, a bending angle of the heating element ranges from 10° to 170°, and preferably, 80° to 100°. Optionally, the connector includes an electrode plate and a support sheet, the electrode plate is electrically connected to an end of the heating element, and

the electrode plate is configured to electrically connect the heating element to an external power supply. The support sheet is connected to the electrode plate to support the electrode plate.

The support sheet is embedded in the liquid absorbing element. The electrode plate is at least partially exposed to the liquid absorbing element.

Optionally, the connector includes at least two support sheets, and the two support sheets are respectively connected to two opposite ends of the electrode plate.

A through groove is formed on each of the support sheets, and the liquid absorbing element partially permeates into the through groove.

In order to resolve the foregoing technical problem, this application adopts another technical solution as follows. A vaporizer is provided. The vaporizer includes a vaporization sleeve, a mounting base, and a vaporization core. The vaporization core is the vaporization core as described above.

In order to resolve the foregoing technical problem, this application adopts another technical solution as follows. An electronic vaporization device is provided. The electronic vaporization device includes:
a vaporizer, configured to store a vaporizable liquid and vaporize the vaporizable liquid to form smoke inhalable by a user, where the vaporizer is the vaporizer as described above; and
a body assembly, configured to supply power to the vaporizer.

Beneficial effects of this application are as follows. This application provides an electronic vaporization device and a vaporizer thereof and a vaporization core. By embedding the heating module in the liquid absorbing element, the heating module may be snugly attached to the liquid absorbing element, so that the heat generated by the heating module can be quickly transferred into the liquid absorbing element. Therefore, not only the excess temperature of the heating module can be prevented, but also the rapid temperature rise of the ceramic substrate can also be ensured. In addition, the heating module may absorb heat from a surface of the liquid absorbing element, so that finally the surface temperature of the heating surface of the liquid absorbing element is uniform without the phenomenon of a local excess temperature. In addition, by bending the heating module into a three-dimensional structure, the vaporizable liquid in the liquid absorbing element may be preheated by the heating module, and then the temperature of the vaporizable liquid can be uniformly raised, thereby improving the vaporization effect of the vaporizable liquid. This solution has a good heating effect for the vaporizable liquid with high viscosity and poor fluidity. By arranging a plurality of through holes on the heating element, the contact area between the heating element and the liquid absorbing element can be increased, so that the heat emitted by the heating element can be uniformly and rapidly diffused into the liquid absorbing element. In this way, the local temperature of the linear heating element may be prevented from being excessively high as a result of the heat accumulation in the local area of the linear heating element due to poor contact with the liquid absorbing element, and it may also be ensured that the liquid absorbing element can be quickly and uniformly heated. Therefore, the vaporization effect of the vaporizable liquid can be improved.

In order to make the technical problem to be solved, the adopted technical solutions, and the achieved technical effect of this application clearer, the technical solutions of embodiments of this application are to be further described in detail below with reference to the accompanying drawings.

In order to make the technical problem to be solved, the adopted technical solutions, and the achieved technical effect of this application clearer, the technical solutions of embodiments of this application are to be further described in detail below with reference to the accompanying drawings.

The terms “first” and “second” in this application are merely intended for a purpose of description, and shall not be understood as indicating or implying relative significance or implicitly indicating the number of indicated technical features. Therefore, a feature restricted by “first” or “second” may explicitly indicate or implicitly include at least one of such features. In description of this application, “a plurality of” means at least two, such as two and three, unless otherwise specifically defined. All directional indications (for example, up, down, left, right, front, back) in the embodiments of this application are only used for explaining relative position relationships, movement situations, or the like between the various components in a specific posture (as shown in the accompanying drawings). If the specific posture changes, the directional indications change accordingly. In addition, the terms “include”, “have”, and any variant thereof are intended to cover a non-exclusive inclusion. For example, a process, a method, a system, a product, or a device that includes a series of steps or units is not limited to the listed steps or units, and instead, further optionally includes a step or unit that is not listed, or further optionally includes another step or unit that is intrinsic to the process, method, product, or device.

Embodiments mentioned in the specification mean that particular features, structures, or characteristics described with reference to the embodiments may be included in at least one embodiment of this application. The term appearing at different positions of this specification may not be the same embodiment or an independent or alternative embodiment that is mutually exclusive with other embodiments. A person skilled in the art explicitly or implicitly understands that the embodiments described in the specification may be combined with other embodiments.

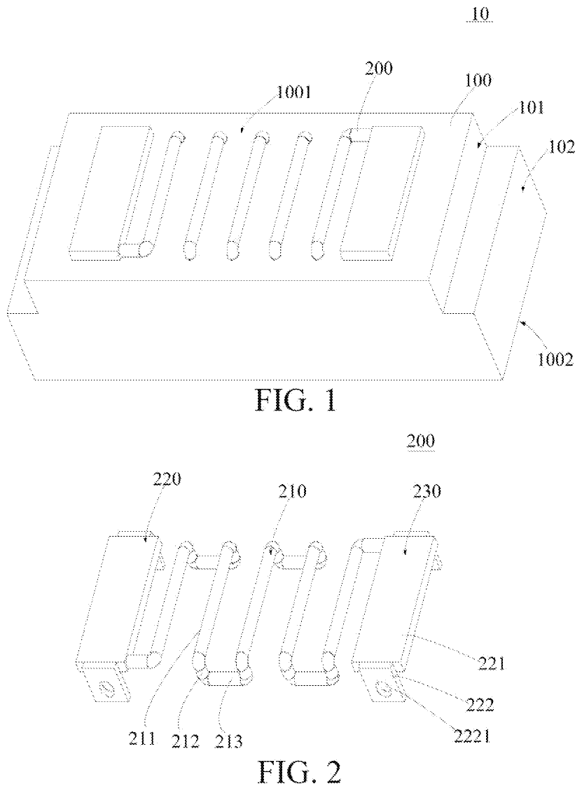

Referring to FIG. 1 and FIG. 2, FIG. 1 is a schematic structural diagram of an embodiment of a vaporization core according to this application. FIG. 2 is a schematic structural diagram of a heating module in the vaporization core shown in FIG. 1.

A vaporization core 10 includes a liquid absorbing element 100 and a heating module 200. The vaporization core 10 may be configured to heat the vaporizable liquid to vaporize the vaporizable liquid.

A plurality of micro-pores are formed in the liquid absorbing element 100. The vaporizable liquid can enter the liquid absorbing element 100 through the micro-pores, or the vaporizable liquid may also permeate from one side to an other side of the liquid absorbing element 100 through the micro-pores.

The plurality of micro-pores in the liquid absorbing element 100 may further function to store the vaporizable liquid. The heating module 200 is partially embedded in the liquid absorbing element 100.

The liquid absorbing element 100 may be a sintered porous body. Specifically, the sintered porous body may be a ceramic porous body. It may be understood that, in some other embodiments, the sintered porous body may not be limited to the ceramic porous body. For example, the sintered porous body may be a glass porous body or a glass ceramic porous body.

The material of the liquid absorbing element 100 may be any one or more of alumina, silica, silicon nitride, silicate, and silicon carbide.

Specifically, the powder (or slurry) of a mixture of any one or more of alumina, silica, silicon nitride, silicate, and silicon carbide may be first used to form the blank of the liquid absorbing element 100, and then the heating module 200 is at least partially embedded in the blank, so that the liquid absorbing element 100 partially embedded in the heating module 200 can be formed by heating and sintering, and the heating module 200 is snugly combined with the liquid absorbing element 100.

The shape and the size of the liquid absorbing element 100 are not limited, and may be selected as required. In this embodiment, specifically, the liquid absorbing element 100 includes a body portion 102 which is roughly cuboid, for example, a stepped body portion, and a boss portion 101 arranged on a bottom surface of the body portion 102. The heating module 200 may be partially embedded in the boss portion 101. A part of the heating module 200 located outside the liquid absorbing element 100 may be arranged on a side of a top surface of the boss portion 101 (that is, a side of the boss portion 101 away from the body portion 102). In this embodiment, the liquid absorbing element 100 is integrally formed.

The top surface of the boss portion 101 of the liquid absorbing element 100 is a vaporization surface 1001 of the liquid absorbing element 100, and a surface of the other side of the liquid absorbing element 100 opposite to the vaporization surface 1001 may be represented as a liquid absorbing surface 1002 of the liquid absorbing element 100. The liquid absorbing surface 1002 of the liquid absorbing element 100 may contact the vaporizable liquid, so that the vaporizable liquid can enter the liquid absorbing element 100 from the side of the body portion 102 away from the boss portion 101, and may permeate out from the top surface of the boss portion 101 (that is, the vaporizable liquid may extend through the liquid absorbing element 100 through the liquid absorbing surface 1002 of the liquid absorbing element 100 and then permeate out from the vaporization surface 1001 of the liquid absorbing element 100). When the vaporizable liquid permeates from the top surface of the boss portion 101, the part of the heating module 200 outside the liquid absorbing element 100 can heat and vaporize the permeated vaporizable liquid. Further, a groove may be further arranged on a side of the body portion 102 of the liquid absorbing element 100 away from the boss portion 101, and is used for accommodating the vaporizable liquid.

In this embodiment, the heating module 200 is embedded in the liquid absorbing element 100, so that the heating module 200 can be snugly attached to the liquid absorbing element 100, thereby improving the heat conduction uniformity of the heating module 200. In addition, by embedding the heating module 200 in the liquid absorbing element 100, the heating module 200 may further preheat the vaporizable liquid in the liquid absorbing element 100 in a process that the vaporizable liquid enters the liquid absorbing element 100 from the side of the body portion 102 away from the boss portion 101 and permeates out from the top surface of the boss portion 101, so that the temperature of the vaporizable liquid can be uniformly raised, thereby improving the vaporization effect of the vaporizable liquid. In addition, for the vaporizable liquid with high viscosity, the part of the heating module 200 embedded in the liquid absorbing element 100 may preheat the vaporizable liquid to reduce the viscosity of the vaporizable liquid, thereby improving the fluidity and preventing dry burning due to insufficient liquid supply to the vaporization surface.

In this embodiment, further, the heating module 200 is arranged as a stereoscopic structure, thereby further improving the vaporization effect of the vaporizable liquid.

For details, reference is made to FIG. 2.

In this embodiment, the heating module 200 may include a heating element 210, a first connector 220, and a second connector 230. The first connector 220 and the second connector 230 may be respectively connected to two opposite ends of the heating element 210.

The heating element 210 may include a first heating portion 211 and a second heating portion which are connected.

One first heating portion 211 and one second heating portion may be arranged. One end of the first heating portion 211 may be connected to the first connector 220, an other end is connected to the second heating portion, and an end of the second heating portion away from the first heating portion 211 is connected to the second connector 230.

Alternatively, at least two first heating portions 211 may be arranged. The two first heating portions 211 may be respectively connected to the first connector 220 and the second connector 230, and the second heating portion may be connected in series between the two first heating portions 211.

Specifically, the second heating portion may include at least two first heating sub-portions 212 and a second heating sub-portion 213. Two ends of the first heating sub-portions 212 are respectively connected to the first heating portion 211 and the second heating sub-portion 213.

In this embodiment, the heating element 210 may be a linear heating unit, and the first heating portion 211 and the second heating sub-portion 213 are both linear. The heating element 210 may be bent a plurality of times to form a plurality of first heating portions 211, a plurality of first heating sub-portions 212, and a plurality of second heating sub-portions 213. The plurality of second heating sub-portions 213 are embedded in the liquid absorbing element 100. That is to say, a side surface of each of the second heating sub-portions 213 is completely covered by the porous ceramic material of the liquid absorbing element 100, and the end is connected to an adjacent first heating sub-portion 212.

In this embodiment, when the heating element 210 is bent a plurality of times to form a plurality of first heating portions 211, a plurality of first heating sub-portions 212, and a plurality of second heating sub-portions 213. A bent portion may be formed between two connected heating portions (the first heating portion 211, the first heating sub-portion 212, or the second heating sub-portion 213), and a bending angle of the bent portion ranges from 10° to 170°. For example, the first heating portion 211 and the first heating sub-portion 212 which are connected are used as an example. The first heating portion 211 and the first heating sub-portion 212 are both linear, and a joint between the first heating portion 211 and the first heating sub-portion 212 may be a bent portion. The bending angle of the bent portion may range from 10° to 170°. Preferably, the bending angle of the bent portion may range from 80° to 100°. For example, the bending angle of the bent portion between the first heating portion 211 and the first heating sub-portion 212 may be set to 80°, 90°, or 100°. In a preferred implementation, the bending angle of the bent portion may be set to 90°. The heating element 210 may be a metal strip or wire, and a cross-section of the heating element 210 may be in the shape of any of a circle, a square, a rectangle, an ellipse, and the like. In other embodiments, the cross-section of the heating element 210 may also be in the shape of a regular polygon such as a regular hexagon or a regular octagon.

In this embodiment, the heating element 210 constitutes a three-dimensional structure. The plurality of first heating portions 211 in the heating element 210 may be all arranged in a first plane, and the plurality of second heating sub-portions 213 may be arranged in a second plane spaced apart from the first plane. In a preferred implementation, the first plane may be parallel to and spaced apart from the second plane. That is to say, central connecting lines of the first heating portions 211 in the heating element 210 may be all arranged in the first plane. Central connecting lines of the plurality of second heating sub-portions 213 in the heating element 210 may be all arranged in the second plane. The first plane is parallel to and spaced apart from the second plane. The plurality of first heating sub-portions 212 in the heating element 210 may connect the plurality of first heating portions 211 to the plurality of second heating sub-portions 213. Specifically, two opposite ends of each of the first heating sub-portions 212 may be respectively connected to the first heating portion 211 and the second heating sub-portion 213.

In this embodiment, the plurality of first heating portions 211 are parallel and arranged at intervals in the first plane.

The plurality of second heating sub-portions 213 are arranged in the second plane parallel to the first plane, and the plurality of first heating sub-portions 212 may be arranged in a third plane perpendicular to the first plane. Since the first heating portion 211 may be a linear heating element, and two opposite ends of the first heating portion may be both connected to the second heating portion, two third planes may be arranged, so that the first heating sub-portions 212 on two opposite sides of the first heating portion 211 are respectively located in the two third planes. The two third planes may also be arranged at intervals and in parallel.

In this implementation, the first plane is a plane where the vaporization surface 1001 is located.

Further, in this embodiment, the heating element 210 may be a metal strip or a metal wire, or may be a patterned metal sheet. The heating element 210 may be made of any of metal alloys such as a Fe—Cr alloy, a Fe—Cr aluminum alloy, a Fe—Cr nickel alloy, a Cr—Ni alloy, a titanium alloy, a stainless steel alloy, and a Kama alloy, or may be made of a mixture of at least two alloys.

When the heating element 210 is a metal strip or a metal wire, the diameter of the cross section of the heating element 210 may be in the range of 0.02 mm to 1.00 mm, for example, may be 0.02 mm, 0.5 mm, or 1 mm. When the heating element 210 is a metal sheet, the heating element 210 may be a metal sheet with a thickness in the range of 0.01 mm to 2 mm.

When the heating element 210 is bent to form a plurality of first heating portions 211, a plurality of first heating sub-portions 212, and a plurality of second heating sub-portions 213, the length of each bent part can be set in the range of 0.1 mm to 5 mm. For example, the length of each bent part may be set to 0.1 mm, 2.5 mm, or 5 mm.

As described in the above embodiments, the heating element 210 with a three-dimensional structure is formed by bending a plurality of times. In other implementations, the heating element 210 with a three-dimensional structure may be further obtained by using one or more methods such as die stamping, casting, mechanical weaving, chemical etching, and the like.

Alternatively, in other embodiments, a plurality of heating elements 210 may be woven into a mesh structure by mechanical weaving, and then the formed mesh heating elements are bent to form the heating element 210 with a three-dimensional structure.

Alternatively, a plurality of sub-linear heating elements with smaller diameters may also be used, and the heating element 210 with a larger diameter is formed by winding, bonding, or welding. Then the heating element 210 with a larger diameter is bent to form a three-dimensional structure with the plurality of first heating portions 211, the plurality of first heating sub-portions 212, and the plurality of second heating sub-portions 213.

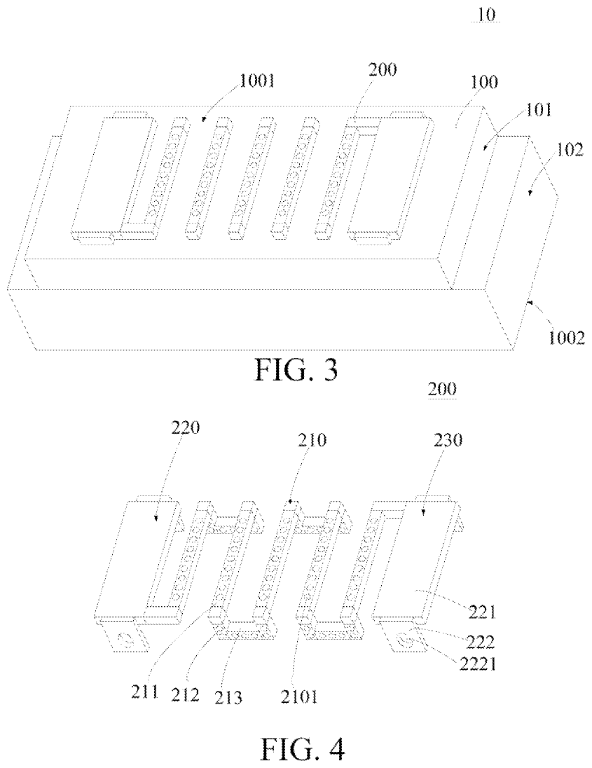

Refer to FIG. 3 to FIG. 4. FIG. 3 is a schematic structural diagram of another implementation of the vaporization core shown in FIG. 1. FIG. 4 is a schematic structural diagram of a heating module in the vaporization core shown in FIG. 3.

In this implementation, a through hole 2101 may further be arranged on a heating unit (including the first heating portion 211, the first heating sub-portion 212, and/or the second heating sub-portion 213) of the heating element 210. A plurality of through holes 2101 may be arranged, and the plurality of through holes 2101 may be sequentially arranged at equal intervals in a length direction of the heating unit. In this solution, the through holes 2101 may be arranged on all of the first heating portion 211, the first heating sub-portion 212, and the second heating sub-portion 213. In other implementations, the plurality of through holes 2101 may be arranged on the first heating portion 211, the first heating sub-portion 212, or the second heating sub-portion 213.

In this implementation, the first heating sub-portion 212 or the second heating sub-portion 213 constitutes a U-shaped second heating portion. In other implementations, the second heating portion may also be V-shaped (that is, two first heating sub-portions 212 are directly connected, and the second heating sub-portion 213 is omitted). In other implementations, the second heating portion may also be arc-shaped.

Therefore, in this implementation, the plurality of through holes are arranged on the heating unit of the heating element 210, so as to further improve the stability of the combination of the heating element 210 and the liquid absorbing element 100, so that the heat emitted by the heating element 210 can be uniformly diffused into the liquid absorbing element 100. In this way, the local temperature of the heating element 210 may be prevented from being excessively high as a result of the heat accumulation in the local area of the heating element 210 due to poor contact with the liquid absorbing element 100, and it may also be ensured that the liquid absorbing element 100 can be quickly and uniformly heated. Therefore, the vaporization effect of the vaporizable liquid can be improved.

It should be noted that in this implementation, the through hole 2101 is formed on the heating element 210 to improve the stability of the combination of the heating element 210 and the liquid absorbing element 100 and the heat conduction uniformity. In other implementations, a plurality of blind holes may be formed on the heating unit of the heating element 210, and similarly, a plurality of blind holes may be sequentially arranged at equal intervals in the length direction of the heating element 210.

When the through hole 2101 is formed on the heating element 210, the through hole 2101 may be a circular hole, and the diameter of the through hole 2101 may be set to be in the range of 0.01-1.00 mm. For example, the diameter of the through hole 2101 may be set to 0.01 mm, 0.5 mm, or 1 mm.

When a blind hole is formed on the heating element 210, the blind hole may be a circular hole or a rectangular hole. When the blind hole is a circular hole, the diameter of the blind hole may be set to be in the range of 0.01-1.00 mm. When the blind hole is a rectangular hole, the width of the blind hole may be set to be in the range of 0.01-1.00 mm, and the length may be set to be in the range of 0.10-2.00 mm.

The distance between two adjacent through holes 2101 (or blind holes) may be set to be in the range of 0.03 mm to 1.00 mm.

Further, as described above, the heating module 200 is partially embedded in the liquid absorbing element 100. Specifically, the second heating sub-portion 213 and at least part of the first heating sub-portion 212 may be embedded in the liquid absorbing element 100. That is to say, the first heating portion 211 of the heating element 210 may be completely or partially exposed outside the liquid absorbing element 100, the second heating sub-portion 213 may be embedded in the liquid absorbing element 100, and the first heating sub-portion 212 may be completely or partially embedded in the liquid absorbing element 100. The first heating sub-portion 212 is partially embedded in the liquid absorbing element 100, which means that a part of a side close to the connection end of the first heating sub-portion 212 and the second heating sub-portion 213 is embedded in the liquid absorbing element 100.

In this implementation, the plurality of second heating sub-portions 213 are all embedded in the liquid absorbing element 100, and the plurality of first heating sub-portions 212 are inserted into the liquid absorbing element 100 with one end exposed and connected to the first heating portion 211. The plurality of first heating portions 211 are all exposed and arranged on the top surface of the boss portion 101.

Optionally, the plurality of first heating portions 211 may be all arranged on a side of the vaporization surface 1001 in the liquid absorbing element 100 and contact the vaporization surface 1001. The vaporization surface 1001 may be a plane. In this way, the consistency of the vaporization heating of the vaporization surface 1001 by the first heating portion 211 can be increased, and the vaporization efficiency can be improved. Similarly, the liquid absorbing surface 1002 may also be a plane, so that the consistency of the liquid guide rate of the vaporizable liquid is good.

Therefore, the part of the heating module 200 located in the liquid absorbing element 100 may preheat the vaporizable liquid in the liquid absorbing element 100, while the part of the heating module 200 located outside the liquid absorbing element 100 may further heat the preheated vaporizable liquid permeated from the liquid absorbing element 100, so that the vaporizable liquid can be quickly and uniformly vaporized.

Further refer to FIG. 2 or FIG. 4.

In this embodiment, the first connector 220 and the second connector 230 of the heating module 200 may be two heating electrode plates. The first connector 220 and the second connector 230 may be respectively connected to two opposite ends of the heating element 210 to form positive and negative electrodes of the heating element 210. By arranging a connecting wire on the first connector 220 and the second connector 230, the heating element 210 may be electrically connected to an external power source, so that the heating element 210 can be supplied with power, and the heating element 210 can generate heat.

Specifically, the first connector 220 and the second connector 230 may each include an electrode plate 221 and a support sheet 222. The electrode plates 221 of the first connector 220 and the second connector 230 may be respectively connected to two opposite ends of the heating element 210. The electrode plate 221 may be arranged on the same plane as the first heating portion 211, that is, a center line of the electrode plate 221 is located in the first plane. One end of the support sheet 222 is connected to the electrode plate 221, and an other end extends in a direction close to the second plane.

In this embodiment, the heating module 200 may be partially embedded in the blank of the liquid absorbing element 100 by gradually embedding the support sheet 222 away from the electrode plate 221 into the blank of the liquid absorbing element 100. A through groove 2221 may further be arranged on the support sheet 222. When the support sheet 222 is gradually embedded in the blank of the liquid absorbing element 100, the powder or slurry forming the liquid absorbing element 100 may enter the through groove 2221. After the blank of the liquid absorbing element 100 is sintered and fixed, the bonding stability of the heating module 200 and the liquid absorbing element 100 can be further improved.

In this embodiment, the first connector 220 or the second connector 230 may each include at least two support sheets 222, and the two support sheets 222 may be respectively connected to two opposite ends of the electrode plate 221.

It should be noted that the electrode plate 221 and the support sheet 222 of the first connector 220 and the second connector 230 may be both integrally formed. Specifically, a sheet material may be formed first, and then two opposite ends of the sheet material are bent. The two opposite ends of the bent sheet material can form the support sheet 222, and a middle area of the sheet material can form the electrode plate 221.

Alternatively, in other implementations, the electrode plate 221 and the support sheet 222 of the first connector 220 and the second connector 230 may be separately formed. The support sheet 222 may be fixedly connected to the two opposite ends of the electrode plate 221 by bonding or welding, so that the first connector 220 or the second connector 230 can be formed.

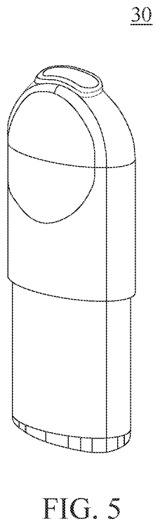

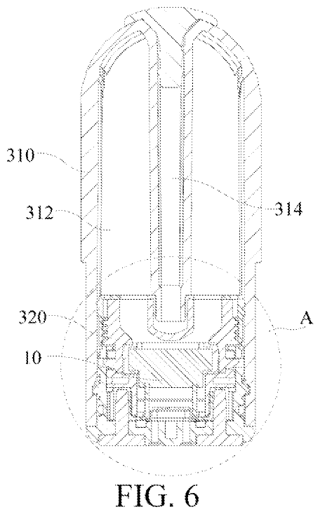

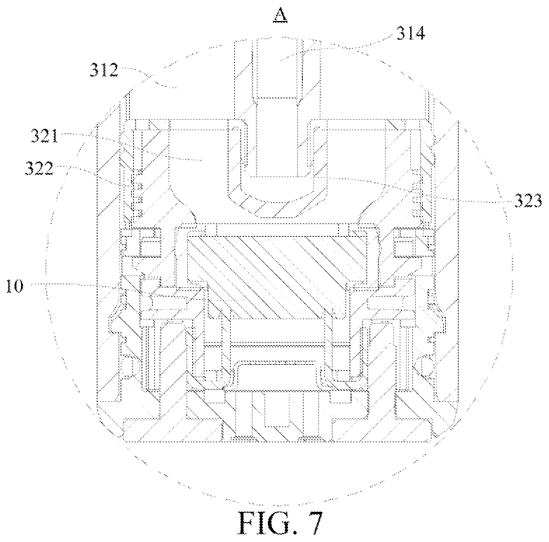

Further, this application further provides a vaporizer. Refer to FIG. 5 to FIG. 7. FIG. 5 is a schematic structural diagram of an embodiment of a vaporizer according to this application. FIG. 6 is a cross-sectional view of the vaporizer shown in FIG. 5. FIG. 7 is a partial enlarged view of the vaporizer shown in FIG. 6 in a region A.

The vaporizer 30 includes a vaporization sleeve 310, a mounting base 320, and a vaporization core 10.

The vaporization sleeve 310 includes a liquid storage cavity 312, and a vent tube 314 is arranged in the vaporization sleeve 310. The liquid storage cavity 312 is configured to store a vaporizable liquid, and the vent tube 314 is configured to guide vapor to a mouth of a user.

The mounting base 320 is provided with a first pressure regulating channel 322, a liquid inlet cavity 321, and a vapor outlet 323. The first pressure regulating channel 322 is circuitously arranged on a periphery of the liquid inlet cavity 321. The mounting base 320 is embedded in the vaporization sleeve 310, and the first pressure regulating channel 322 and the liquid inlet cavity 321 are both in communication with the liquid storage cavity 312. The liquid inlet cavity 321 guides the vaporizable liquid to the vaporization core 10, so that the vaporization core 10 vaporizes the vaporizable liquid to form vapor. The vent tube 314 is connected to the vapor outlet 323, to guide the vapor to an oral cavity of the user through the vapor outlet 323.

The vaporization core 10 is connected to an end of the mounting base 320 away from the liquid storage cavity 312 and blocks the liquid inlet cavity 321, so that the vaporization sleeve 310, the mounting base 320, and the vaporization core 10 form a liquid storage space. After the vaporizable liquid is stored in the liquid storage space, the vaporizable liquid seals the first pressure regulating channel 322.

When an outer air pressure changes or the balance between an air pressure in the liquid storage cavity 312 and the outer air pressure is lost due to inhalation, for example, when the air pressure in the liquid storage cavity 312 is excessively large, the vaporizable liquid may leak between the mounting base 320 and an inner wall of the vaporization sleeve 310, or the vaporizable liquid may leak from the vaporization core 10, or the vaporizable liquid may leak from a joint between the vaporization core 10 and the mounting base 320. Alternatively, when the air pressure in the liquid storage cavity 312 is excessively low, due to the influence of a pressure difference between the inside and the outside of the liquid storage cavity 312, liquid flowing of the vaporizable liquid may be not smooth, and the vaporization core 10 may generate a burnt flavor during operation due to insufficient liquid supply, bringing the user poor inhalation experience.

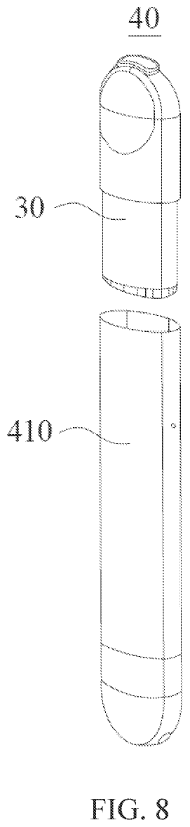

Further, this application further provides an electronic vaporization device. Refer to FIG. 8. FIG. 8 is a schematic structural diagram of an embodiment of an electronic vaporization device according to this application.

An electronic vaporization device 40 includes a vaporizer 30 and a body assembly 410. The vaporizer 30 may be configured to store vaporizable liquid and vaporize the vaporizable liquid to form vapor for a user to inhale. The vaporizer 30 may be mounted to the body assembly 410, and a power supply assembly is arranged in the body assembly 410. When the vaporizer 30 is mounted to the body assembly 410, a positive electrode and a negative electrode of the power supply assembly in the body assembly 410 may be electrically connected to the two electrode plates 221 of the first connector 220 and the second connector 230 respectively, so as to form a power supply circuit to supply power to the heating element 210.

Based on the above, those skilled in the art can easily understand the beneficial effects as follows. By embedding the heating module in the liquid absorbing element, the heating module may be snugly attached to the liquid absorbing element, so that the heat generated by the heating module can be quickly transferred into the liquid absorbing element. Therefore, not only the excess temperature of the heating module can be prevented, but also the rapid temperature rise of the ceramic substrate can also be ensured. In addition, the heating module may absorb heat from a surface of the liquid absorbing element, so that finally the surface temperature of the heating surface of the liquid absorbing element is uniform without the phenomenon of a local excess temperature. In addition, by bending the heating module into a three-dimensional structure, the vaporizable liquid in the liquid absorbing element may be preheated by the heating module, and then the temperature of the vaporizable liquid can be uniformly raised, thereby improving the vaporization effect of the vaporizable liquid. This solution has a good heating effect for the vaporizable liquid with high viscosity and poor fluidity. By arranging a plurality of through holes on the heating element, the contact area between the heating element and the liquid absorbing element can be increased, so that the heat emitted by the heating element can be uniformly and rapidly diffused into the liquid absorbing element. In this way, the local temperature of the linear heating element may be prevented from being excessively high as a result of the heat accumulation in the local area of the linear heating element due to poor contact with the liquid absorbing element, and it may also be ensured that the liquid absorbing element can be quickly and uniformly heated. Therefore, the vaporization effect of the vaporizable liquid can be improved.

The foregoing descriptions are merely embodiments of this application, and are not intended to limit the patent scope of this application. All equivalent structures or process changes made according to the content of this specification and accompanying drawings in this application or direct or indirect application in other related technical fields shall fall within the protection scope of this application.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

What is claimed is:

1. A vaporization core, comprising:
a liquid absorbing element comprising a vaporization surface and a liquid absorbing surface that are oppositely arranged, the liquid absorbing element being configured for a vaporizable liquid to enter from a side of the liquid absorbing surface and permeate toward a side of the vaporization surface; and
a heating module comprising a heating element configured to heat the vaporizable liquid and connectors connected to two ends of the heating element, the heating element comprising a first heating portion and a second heating portion connected in series to the first heating portion,
wherein the first heating portion is arranged on a side of the vaporization surface, and
wherein the second heating portion is embedded in the liquid absorbing element, extends toward a side of the liquid absorbing surface, and is located between the vaporization surface and the liquid absorbing surface.

2. The vaporization core of claim 1, wherein the vaporization surface comprises a plane.

3. The vaporization core of claim 1, wherein at least two first heating portions are arranged, each of the two first heating portions being connected to one of the connectors, and the second heating portion being connected in series between the at least two first heating portions.

4. The vaporization core of claim 3, wherein at least two second heating portions are arranged, and two ends of each of the at least two second heating portions are respectively connected in series to a corresponding one of the first heating portions,
wherein each of the at least second heating portions comprises at least two first heating sub-portions and a second heating sub-portion, and two ends of each of the first heating sub-portions are respectively connected to the first heating portion and the second heating sub-portion, and
wherein the at least two first heating portions are arranged in a first plane, and the second heating sub-portion is arranged in a second plane spaced apart from the first plane.

5. The vaporization core of claim 4, wherein the at least two first heating portions are both arranged on a side of the vaporization surface and contact the vaporization surface.

6. The vaporization core of claim 5, wherein the second plane is parallel to and spaced apart from the first plane.

7. The vaporization core of claim 1, wherein the heating element comprises a linear heating unit, and
wherein the first heating portion and the second heating sub-portion are both linear.

8. The vaporization core of claim 7, wherein a plurality of through holes or blind holes are formed on the heating element, and
wherein the plurality of through holes or blind holes are arranged at intervals in a length direction of the heating element.

9. The vaporization core of claim 8, wherein the heating element comprises a metal sheet, and wherein the heating element is integrally formed with the connectors arranged at two ends of the heating element.

10. The vaporization core of claim 8, wherein the heating element comprises a metal wire, and wherein the heating element is bent a plurality of times to form the at least two first heating portions and the second heating portion.

11. The vaporization core of claim 10, wherein a bending angle of the heating element ranges from 10° to 170°.

12. The vaporization core of claim 7, wherein the connector comprises an electrode plate and a support sheet, the electrode plate being electrically connected to an end of the heating element, the electrode plate being configured to electrically connect the heating element to an external power supply, and the support sheet is connected to the electrode plate to support the electrode plate, and
wherein the support sheet is embedded in the liquid absorbing element, and the electrode plate is at least partially exposed to the liquid absorbing element.

13. The vaporization core of claim 12, wherein the connector comprises at least two support sheets, and the at least two support sheets are respectively connected to two opposite ends of the electrode plate, and
wherein a through groove is formed on each of the support sheets, and the liquid absorbing element partially permeates into the through groove.

14. A vaporizer, comprising:
a vaporization sleeve;
a mounting base; and
the vaporization core of claim 1.

15. An electronic vaporization device, comprising:
the vaporizer of claim 14 configured to store a vaporizable liquid and vaporize the vaporizable liquid to form smoke inhalable by a user; and
a body assembly configured to supply power to the vaporizer.

16. The vaporization core of claim 11, wherein the bending angle of the heating element ranges from 80° to 100°.
